(19) United States
(12) Patent Application Publication
(10) Pub. No.: US 2010/0239429 A1
(43) Pub. Date: Sep. 23, 2010

(54) WEAR PROTECTION COATING

(75) Inventors: Wolfgang Eichmann, Puchheim (DE); Falko Heutling, Munchen (DE); Thomas Uihlein, Dachau (DE)

Correspondence Address: HOWISON & ARNOTT, L.L.P, P.O. BOX 741715, DALLAS, TX, 75374-1715, US

(73) Assignee: MTU AERO ENGINES, GMBH, MUNICH (DE)

(21) Appl. No.: 12/738,829

(22) PCT Filed: Oct. 10, 2008
(86) PCT No.: PCT/DE08/01668

§ 371 Date: Apr. 19, 2010

(30) Foreign Application Priority Data
Oct. 19, 2007 (DE) 10 2007 050 141.4

(51) Int. Cl. F01D 5/14; B32B 3/00

(52) U.S. Cl. 416/241 R; 428/142

(57) ABSTRACT

The English-language Abstract from the international application is to be retained and is therefore not duplicated in the specification.

### CROSS-REFERENCE TO RELATED APPLICATIONS

This application is a U.S. National Phase application submitted under 35 U.S.C. §371 of Patent Cooperation Treaty application serial no. PCT/DE2008/001668, filed 10 Oct. 2008, and entitled WEAR PROTECTION COATING, which application claims priority to German patent application serial no. 10 2007 050 141.4, filed 19 Oct. 2007, and entitled VERSCHLEISSSCHUTZBESCHICHTUNG, the specifications of which are incorporated herein by reference in their entireties.

### TECHNICAL FIELD

The invention concerns a wear protection coating, in particular an erosion protection coating, preferably for gas turbine components, according to the general terms of the claims.

### BACKGROUND

Fluid-mechanically stressed components, such as, for example, gas turbine components, are subject to wear due to oxidation, corrosion, and erosion. A wear process is involved during erosion, which is caused by solid matter moved along with the flow of gas. In order to extend the service life of components that are stressed fluid mechanically, wear protection coatings are required which protect the components from wear, especially from erosion, corrosion, and oxidation.

A multiple-layer, erosion-resistant coating for the surfaces of substrates is known from EP0674020B1. The erosion-resistant coat disclosed there provides a wear protection coating which consists of several multilayer systems applied repetitively to the substrate to be protected. Thus, in EP0674020B1, the multilayer systems applied repetitively are formed of two different layers each namely, on the one hand, a layer of a metallic material and on the other hand a layer of titanium diboride.

EP0366289A1 discloses a further erosion-resistant as well as corrosion-resistant coating for a substrate. Also according to EP0366289A1, the wear protection coating is formed of several multilayer systems applied repetitively to the substrate to be coated, in which each multilayer system consists in turn of two different layers, namely a metallic layer, of titanium for instance, and a ceramic layer, for example of titanium nitride.

A further erosion-resistant, wear protection coating is known from EP0562108B1. Thus, the wear protection coating disclosed there is formed in turn of several multilayer systems applied repetitively to a substrate to be coated. At the same time, FIG. 4 of EP0562108B1 discloses a wear protection coating formed of several multilayer systems applied repetitively, in which each multilayer system consists of four layers.

The wear protection coatings are preferably vaporized onto the surface of a component to be coated and consequently to be protected, in which a wear protection coating can increase the roughness of an outer, flow-relevant surface of the component. The increase in roughness is aerodynamically unfavorable, since loss of flow can develop. Furthermore, an increase in roughness can lead to faster and more severe fouling, since the deposition of contamination on rough surfaces can occur more readily. Increased roughness also causes accelerated attack upon the surface of the component by erosion due to hard particles. Therefore, there exists a need to improve wear protection coatings.

### SUMMARY

Proceeding from this, the basis of the problem for the present invention is to create a new type of wear protection coating.

This problem is solved by further improving the wear protection coating mentioned initially, by means of the features of the claims. According to the disclosure, an outer layer is formed as a smoothing layer, which compensates for unevennesses or roughnesses and/or defect sites of the wear protection coating.

It is proposed, with the disclosure presented here, to apply an outer smoothing layer to the original wear protection coating, which compensates for unevennesses or roughnesses or even defect sites in the wear protection coating. A highly smoothed, superfinished surface is thereby provided, which causes a reduction in aerodynamic loss and counteracts fouling of the coated component. In addition, erosion resistance is improved. Additionally, an improvement in oxidation and corrosion resistance can be counted upon.

Preferably, the smoothing layer is formed as a sol-gel layer, which exhibits a thickness on the order of magnitude of the unevennesses or roughnesses and/or defect sites to be compensated for.

### BRIEF DESCRIPTION OF THE DRAWINGS

Preferred improvements of the invention result from the subclaims and the following description. Embodiment examples of the invention are explained in detail using the FIGURE, without being limited thereto.

FIG. 1 shows a highly schematic cross-section through a wear protection coating according to the invention in accordance with one embodiment example of the invention.

### DETAILED DESCRIPTION

The invention presented here concerns a wear protection coating, especially an erosion protection coating, for a surface to be protected of a fluid-mechanically stressed component, especially a component of a gas turbine, such as, for example, a rotor blade or a guide vane of a gas turbine.

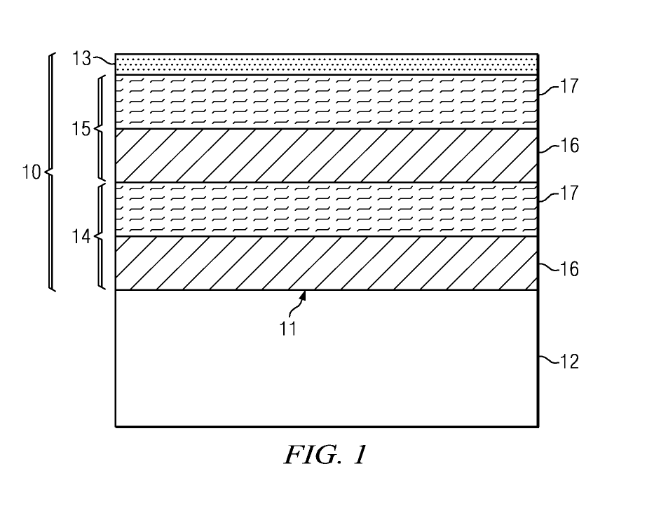

FIG. 1 shows a highly schematic cross-section through a wear protection coating 10 according to the invention, which is applied to an outer surface 11 of a component 12, especially a gas turbine vane, which is stressed fluid mechanically.

An outer layer of the wear protection coating 10 according to the invention is formed as a smoothing layer 13, in which the smoothing layer 13 compensates for unevennesses or roughnesses and/or defect sites of the original wear protection coating.

At the same time, the smoothing layer 13 exhibits a thickness that is on the order of magnitude of the unevennesses or roughnesses and/or defect sites to be compensated for. The smoothing layer 13 preferably exhibits a thickness between 1 μm and 10 μm. Preferably, the thickness of the smoothing layer is between 5 μm and 10 μm. Alternatively, the thickness of the smoothing layer can be between 1 μm and 5 μm.

As already stated, the smoothing layer 13 forms the outer stratum or layer of the wear protection coating according to the invention, whereby, in the embodiment example shown in FIG. 1, two multilayer systems 14, 15 are applied to the surface 11 to be coated of the component 12, and in which each multilayer system 14, 15 includes a relatively soft, metallic layer 16 and a relatively hard, ceramic layer 17. The outer smoothing layer 13 is applied to the outer, relatively hard, ceramic layer 17 of the outer multilayer system 15.

The smoothing layer 13 of the wear protection coating according to the invention is executed as a sol-gel layer. A fluid phase, a so-called sol, is applied for this purpose by dipping, spraying or daubing on the outer layer 17 of the outer multilayer system 15 and then drying and hardening by means of tempering.

During the drying and the hardening, the fluid phase, namely the sol, is converted to a solid phase, into a so-called gel. The drying and hardening can be combined with heat treatment.

The application of the smoothing layer 13, formed as a sol-gel layer, to the outer hard layer 17 of the multilayer system 15 presents the advantage that the relatively hard layer 17 provides a protective effect for the relatively thin sol-gel layer and thus the smoothing layer 13, which particularly supports the bonding of the smoothing layer 13 under mechanical load.

Preferably, a sol-gel layer on a silicate base or carbon base or metal oxide base or polymer base is provided as the smoothing layer 13.

Accordingly, in the sense of the invention presented here, a wear protection coating can be provided as an outer layer, which compensates for unevennesses or roughnesses and/or defect sites of the original wear protection coating. The smoothing layer 13 is at the same time preferably formed as a sol-gel layer, with a thickness that is on the order of magnitude of the unevennesses or roughnesses and/or defect sites to be compensated for. Especially preferably, the smoothing layer 13 then finds application when the wear protection coating is formed of several multilayer systems, in which the smoothing layer is then applied to the outer layer of the outer multilayer system.

1-8. (canceled)

9. A wear protection coating, in particular an erosion protection coating, which is applied to a surface to be protected of a fluid-mechanically stressed component, especially of a gas turbine component, the wear protection coating comprising:
an outer layer formed as a smoothing layer, which compensates for unevennesses or roughnesses and/or defect sites in the wear protection coating; and
several multilayer systems applied repetitively to the surface to be protected, in which each multilayer system includes at least a relatively soft metallic layer and at least one relatively hard ceramic layer, so that the outer smoothing layer is applied to an outer, relatively hard, ceramic layer of the outer multilayer system, and the smoothing layer exhibits a thickness on the order of magnitude of the unevennesses or roughnesses and/or defect sites to be compensated for.

10. A wear protection coating according to claim 9, wherein the smoothing layer exhibits a thickness between 1 μm and 10 μm.

11. A wear protection coating according to claim 10, wherein the smoothing layer exhibits a thickness between 1 μm and 5 μm.

12. A wear protection coating according to claim 11, wherein the smoothing layer is formed as a sol-gel layer.

13. A wear protection coating according to claim 12, wherein the sol-gel layer is formed on one of a silicate base, a metal oxide base, a carbon base or a polymer base.

14. A wear protection coating according to claim 10, wherein the smoothing layer is formed as a sol-gel layer.

15. A wear protection coating according to claim 14, wherein the sol-gel layer is formed on one of a silicate base, a metal oxide base, a carbon base or a polymer base.

16. A wear protection coating according to claim 9, wherein the smoothing layer is formed as a sol-gel layer.

17. A wear protection coating according to claim 16, wherein the sol-gel layer is formed on one of a silicate base, a metal oxide base, a carbon base or a polymer base.

18. An article for a gas turbine, the article comprising:
a component having an outer surface to be protected; and
a wear protection coating disposed over the outer surface to be protected, the wear protection coating including an inner multilayer system, an outer multilayer system and a smoothing layer;
the inner multilayer system including a first metallic layer and a first ceramic layer;
the first metallic layer being disposed over the outer surface to be protected;
the first ceramic layer being disposed over the first metallic layer and being relatively hard with respect to the first metallic layer;
the outer multilayer system including a second metallic layer and a second ceramic layer;
the second metallic layer being disposed over the inner multilayer system;
the second ceramic layer being disposed over the second metallic layer, being relatively hard with respect to the second metallic layer, and having an outer surface characterized by at least one of unevenness, roughness or defect sites defining a thickness dimension to be compensated for;
the smoothing layer being disposed over the second ceramic layer, the smoothing layer exhibiting a thickness that is on the order of magnitude to the thickness dimension to be compensated for;
whereby the smoothing layer compensates for the unevenness, roughness or defect sites of the second ceramic layer.

19. An article for a gas turbine according to claim 18, wherein the smoothing layer exhibits a thickness between 1 μm and 10 μm.

20. An article for a gas turbine according to claim 19, wherein the smoothing layer exhibits a thickness between 1 μm and 5 μm.

21. An article for a gas turbine according to claim 18, wherein the smoothing layer exhibits the characteristics, when dried and hardened, of a layer that was applied in a fluid phase.

22. An article for a gas turbine according to claim 21, wherein the smoothing layer is one of a silicate base, a metal oxide base, a carbon base and a polymer base.

23. An article for a gas turbine according to claim 18, wherein the smoothing layer is relatively thin with respect to the second ceramic layer.

24. An article for a gas turbine, the article comprising:
a component having an outer surface to be protected;
a wear protection coating disposed over the outer surface to be protected, the wear protection coating including an inner multilayer system and an outer multilayer system;
the inner multilayer system including a first relatively soft metallic layer disposed over the outer surface to be protected and a first relatively hard ceramic layer disposed over the first metallic layer;
the outer multilayer system including a second relatively soft metallic layer disposed over the inner multilayer system and a second relatively hard ceramic layer disposed over the second metallic layer;
the outer surface of the outer multilayer system having at least one of unevenness, roughness or defect sites defining a thickness dimension; and
a smoothing layer disposed over the outer multilayer system, the smoothing layer having thickness characteristics of a layer that was applied in a fluid phase and then dried and hardened such that the unevenness, roughness or defect sites defining the thickness dimension are reduced.

25. An article for a gas turbine according to claim 24, wherein the smoothing layer is formed from one of a silicate base, a metal oxide base, a carbon base and a polymer base.

26. An article for a gas turbine according to claim 24, wherein the smoothing layer is relatively thin with respect to the second ceramic layer.

27. An article for a gas turbine according to claim 24, wherein the smoothing layer exhibits a thickness between 1 μm and 10 μm.

28. An article for a gas turbine according to claim 24, wherein the component is one of a rotor blade and guide vane of a gas turbine.
